(19) United States
(12) Patent Application Publication
(10) Pub. No.: US 2007/0128903 A1
(43) Pub. Date: Jun. 7, 2007

(54) CARD LOCKING STRUCTURE

(75) Inventor: TERUYUKI MORI, Kanagawa (JP)

Correspondence Address: MCCORMICK, PAULDING & HUBER LLP, CITY PLACE II, 185 ASYLUM STREET, HARTFORD, CT, 06103, US

(73) Assignee: KYOCERA ELCO CORPORATION, Kanagawa (JP)

(21) Appl. No.: 11/535,616

(22) Filed: Sep. 27, 2006

(30) Foreign Application Priority Data
Dec. 6, 2005 (JP) 2005-352172
Mar. 23, 2006 (JP) 2006-080168

(51) Int. Cl. H01R 13/62

(52) U.S. Cl. 439/159

(57) ABSTRACT

A card locking structure for holding a card between the card locking structure and a card edge-connector provided on a motherboard, one end of the card being inserted into the card edge-connector, includes a locking member made of synthetic resin which is movable relative to the motherboard; and at least one biasing member which biases the locking member toward the card edge-connector. The card is held in a state so that the card is substantially parallel to the motherboard by firstly inserting the one end of the card into the card edge-connector and subsequently accommodating the other end of the card in the locking member.

### CROSS REFERENCE TO RELATED APPLICATION

The present invention is related to and claims priority of the following pending applications, namely, Japanese Patent Application No. 2005-352172, filed on Dec. 6, 2005 and Japanese Patent Application No. 2006-080168, filed on Mar. 23, 2006.

### BACKGROUND OF THE INVENTION

1. Field of the Invention

The present invention relates to a card locking structure for holding a card (secondary board) on a motherboard (primary board), and more specifically, relates to such a card locking structure which is used with a card edge-connector for electrically connecting the card to the motherboard.

2. Description of the Prior Art

A holding structure which holds a card (secondary board) such as a memory card or another type of card on a circuit board (motherboard/primary board) and is used with a card edge-connector for electrically connecting the card to the circuit board, is known in the art. As an example of such a holding structure, a latch is disclosed in Japanese unexamined patent publication 2004-235142.

This latch is installed on a circuit board independently of the associated card edge-connector contained on the circuit board to face the card edge-connector. The latch is provided, at a position corresponding to one end of the card in the lengthwise direction thereof, with a latching portion in the shape of a hook that firstly projects upward and subsequently extends toward the card edge-connector.

When the card is installed on the circuit board, firstly one end of the card which contains electric terminals is inserted into the card edge-connector, and subsequently the card is rotated about this one end of the card in a direction to move the other end of the card toward the latch. This rotation of the card brings the other end thereof in the lengthwise direction to be engaged with an inner part of the latch. This engagement between the card and the latch prevents the card from moving upward, away from the circuit board, thus locking the card in a state where the card is substantially parallel to the circuit board.

In the above described latch, since the latching portion, that is resiliently deformed at the time of installation or removal of the card, is made of a leaf spring which is formed integral with an on-board stationary portion of the latch that is mounted on the circuit board, mechanical stress or bending moment caused by the leaf spring is directly transferred to the joint between the on-board stationary portion and the circuit board, which makes it easy to damage the circuit board, e.g., cause solder fractures. Specifically, the strength of the soldered joint is vulnerable to a bending moment caused by the leaf spring, and accordingly, solder fractures frequently occur in the case where the card is often removed and installed. Additionally, if the size and weight of the latch are reduced, the latching portion becomes small, so that the resiliency of the leaf spring decreases while the possibility of the latch not functioning properly increases.

The dimensional tolerance of the card is usually great, and accordingly, the card needs to be held on the circuit board with the dimensional tolerance being absorbed by the latch. However, since a sufficient spring-resiliency cannot be obtained if the latch becomes small, it is difficult to secure a sufficient stroke of the latch at the time of installation or removal of the card while absorbing the dimensional tolerance of the card. In addition, even within the dimensional tolerance, there is a possibility of a small card becoming easily disengaged from the latch.

If an external force or an acceleration is applied to the latch in a removing direction of the card or a resilient-deforming direction of the latching portion due to a dropping impact or the like when the card is installed/removed or during the use of a device equipped with the card, a distortion and/or a permanent strain (plastic deformation) occurs in the end of the latching portion or the entire latch, which causes the card to easily disengage from the latch.

If the latch is made of metal, there is a high possibility of the user being injured by touching an exposed sharp edge of the latch; moreover, there is a possibility of the card being damaged if the card comes in contact with such an exposed sharp edge when the card is installed or removed.

When the card is inserted in the card edge-connector, it is sometimes the case that the card is inclined to the card inserting direction, i.e., that the card is rotated about an axis which is inclined to (displaced from) one end (terminal-contained end) of the card which is inserted into the card edge-connector (this rotation of the card is hereinafter referred to as a “rotational displacement”). If the card is inserted in such a matter, faulty electrical continuity between the card edge-connector and the card and an insufficient holding state of the card by the latch occur, which may cause the card to fall out. Specifically, the aforementioned rotation displacement tends to occur when the card is improperly inserted into the card edge-connector, or when vibrations and the like which are produced by an external force, falling of an apparatus equipped with the card, an impact, or other causes, are applied to the card after having been properly inserted into the card edge-connector. Moreover, the rotation displacement becomes conspicuous in the case of the card having a long length in the inserting direction.

Furthermore, in the case where there is electrical continuity between the card edge-connector and the card when the rotation displacement occurs, an apparatus equipped with the card may be used even though a poor connection between the card edge-connector and the card remains.

### SUMMARY OF THE INVENTION

In view of the drawbacks of the prior art mentioned above, the present invention provides a card locking structure for holding a card on a motherboard which prevents mechanical stress being transferred to the motherboard, makes it possible to secure a sufficient stroke relative to tolerances of the card, allows the card to be held securely with stability, maintains good operational performance without being deformed, damaged, or causing injury to the operator (user), prevents the card from being damaged, and prevents rotation displacement of the card during insertion thereof.

According to an aspect of the present invention, a card locking structure is provided for holding a card between the card locking structure and a card edge-connector provided on a motherboard, one end of the card being inserted into the card edge-connector, the card locking structure including a locking member made of synthetic resin which is movable relative to the motherboard; and at least one biasing member which biases the locking member toward the card edge-connector. The card is held in a state so that the card is substantially parallel to the motherboard by firstly inserting the one end of the card into the card edge-connector and subsequently accommodating the other end of the card in the locking member.

It is desirable for the biasing member to include a coil spring which is positioned to expand and contract in a direction between the card-edge connector and the locking member.

It is desirable for the locking member to include at least one holding portion which accommodates the other end of the card and which is positioned substantially on an axis of the coil spring.

It is desirable for the card locking structure to include a stationary member made of metal, wherein the locking member is held by the stationary member via the biasing member to be movable relative to the stationary member.

It is desirable for the stationary member to be mounted on the motherboard.

It is desirable for the stationary member to be an element of the motherboard.

It is desirable for the stationary member to constitute a part of a member of a device to which the motherboard and the card are installed.

It is desirable for the stationary member to be mounted on a board different from the motherboard.

It is desirable for a recess in which the coil spring is accommodated to be formed in the locking member.

It is desirable for the stationary member to include at least one mounting portion which is directly mounted to the motherboard, and for a central axis of the mounting portion to be substantially aligned with an axis of the coil spring.

It is desirable for the holding portion to include a locking portion which prevents the card from moving in a direction away from the motherboard, and for a central axis of the locking portion to be substantially aligned with an axis of the coil spring.

It is desirable for the holding portion to include at least two holding portions.

It is desirable for the mounting portion to include at least two mounting portions.

It is desirable for the locking member to move relative to the motherboard while sliding on the motherboard.

It is desirable for the holding portion to include a receiving portion which supports a bottom surface of the card when the holding portion accommodates the other end of the card. The receiving portion includes a protrusion which is engaged in a receiving portion formed in the card when the card locking structure holds the card in the state where the card is substantially parallel to the motherboard.

It is desirable for the protrusion to include a curved outer surface which is curved toward the receiving portion of the card.

It is desirable for the curved outer surface to be spherical in shape.

It is desirable for the curved outer surface to be oval in shape.

It is desirable for the protrusion to be elongated in the widthwise direction of the receiving portion.

It is desirable for the stationary member to include at least one resilient grounding member which comes into resilient contact with at least one ground pattern formed on a bottom surface of the card when the other end of the card is accommodated in the locking member.

It is desirable for the stationary member to include a plurality of stop projections engageable with the locking member to limit a range of movement of the locking member with respect to the stationary member.

It is desirable for the two holding portions to be positioned at opposite ends of the locking member in a widthwise direction thereof.

In an embodiment, a card locking structure is provided for holding and locking one end of a card in a lengthwise direction thereof after the other end of the card in the lengthwise direction is inserted into a card edge-connector, wherein the card locking structure and the card edge-connector are mounted to a motherboard so as to face each other, the card locking structure including a metal stationary member fixed to the motherboard; a plastic locking member supported by the metal stationary member to be slidable thereon; and at least one spring which continuously biases the plastic locking member toward the card edge-connector. The card locking structure holds the card in a state where the card is substantially parallel to the motherboard by firstly inserting the other end of the card into the card edge-connector, subsequently rotating the card about the other end thereof in a direction toward the motherboard, and subsequently pressing the one end of the card against at least one oblique surface formed on the plastic locking member to make the plastic locking member slide on the metal stationary member in a direction away from the card edge-connector against a spring force of the spring to thereby make the one end of the card snap-fit into at least one insertion portion formed on the plastic locking member.

According to the present invention, since the locking member is made of synthetic resin and fixed to the stationary member via the biasing member (coil springs) to be slidable on the stationary member, it possible to prevent mechanical stress or bending moment caused by the biasing member from being directly transferred to the joint between the motherboard and the stationary member.

Adopting at least one coil spring as the biasing member makes it possible to secure a sufficient stroke relative to tolerances of the card due to an excellent spring property of the coil spring. Moreover, since neither the end of the latch nor the entire latch has any portion which is easily warped or worn out, the locking member does not show any unstable behavior, so that the card can be held securely with stability.

Furthermore, since the shape of the card locking structure can be simplified and since an excellent spring property (the sliding property of the locking member) is achieved, the locking member moves with little possibility of the locking member jerking, and maintains good operational performance without being deformed or damaged even if operated in an unexpected manner (e.g., being operated in a manner to induce a jerked motion of the locking member).

Additionally, since the locking member is made of synthetic resin, injury to the operator and damage to the card are prevented.

In addition, the aforementioned rotation displacement is prevented from occurring at the time of installation and even after installation of the card since the protrusion that is engageable in the receiving portion formed in the card is formed on the receiving portion.

### BRIEF DESCRIPTION OF THE DRAWINGS

The present invention will be discussed below in detail with reference to the accompanying drawings, in which:

FIG. 1A is a rear perspective view of an embodiment of a card locking structure according to the present invention in a locked state thereof, viewed obliquely from above;

FIG. 1B is a front perspective view of the card locking structure shown in FIG. 1A in a locked state thereof, viewed obliquely from below;

FIG. 1C is a view similar to that of FIG. 1A and illustrates the card locking structure in an unlocked state thereof;

FIG. 1D is a view similar to that of FIG. 1B and illustrates the card locking structure in an unlocked state thereof;

FIG. 2A is a rear perspective view of a locking member of the card locking structure shown in FIGS. 1A through 1D, viewed obliquely from above;

FIG. 2B is a front perspective view of the locking member shown in FIG. 2A, viewed obliquely from below;

FIG. 3A is a rear perspective view of a stationary member of the card locking structure shown in FIGS.1A through 1D, viewed obliquely from above;

FIG. 3B is a front perspective view of the locking member shown in FIG. 3A, viewed obliquely from below;

FIG. 4A is a front elevational view of a card edge-connector used with the card locking structure shown in FIGS.1A through 1D;

FIG. 4B is a rear elevational view of the card edge-connector shown in FIG. 4A;

FIG. 5 is a perspective view of a card (secondary board) which can be connected to the card edge-connector shown in FIGS. 4A and 4B;

FIGS. 6A through 6D are perspective views of the card shown in FIG. 5 and a circuit board (mother board) to which the card locking structure shown in FIGS.1A through 1D and the card edge-connector shown in FIGS. 4A and 4B are fixed, illustrating the procedure for installing the card to the circuit board and locking the card, wherein FIG. 6A shows a state before the card is inserted into the card edge-connector, FIG. 6B shows a state immediately after the rear end of the card is inserted into the card edge-connector, FIG. 6C shows a state where the front end of the card has been brought to be in contact with leading portions of the locking member, and FIG. 6D shows a locked state of the card in which the front end of the card is positioned in insertion portions of the locking member;

FIG. 7 is a plan view of the card and the circuit board in a state shown in FIG. 6D;

FIG. 8A is a cross sectional view taken along VIII-VIII line shown in FIG. 7, showing a state where the front end of the card has been brought to be in contact with the leading portions of the locking member;

FIG. 8B is a cross sectional view taken along VIII-VIII line shown in FIG. 7, showing a state where the front end of the card is in contact with the ends of the leading portions of the locking member;

FIG. 8C is a cross sectional view taken along VIII-VIII line shown in FIG. 7, showing a state where the front end of the card is positioned in the insertion portions of the locking member;

FIGS. 9A and 9B are views similar to those of FIGS. 8A through 8C, showing another embodiment of the card locking structure, according to the present invention;

FIG. 10 is a perspective view of another embodiment of the card locking structure, according to the present invention;

FIG. 11 is a rear elevational view of the card locking structure shown in FIG. 10;

FIG. 12 is a cross sectional view taken along XI-XII shown in FIG. 11;

FIGS. 13A is a view similar to that of FIG. 12, showing a state where the front end of the card is in contact with the ends of the leading portions of the locking member shown in FIG. 10;

FIGS. 13B is a view similar to that of FIG. 12, showing a locked state of the card in which the front end of the card is positioned in the insertion portions of the locking member shown in FIG. 10; and

FIGS. 14A, 14B and 14C are enlarged plan views of a receiving portion of the card and the engaging projection of an associated holding portion of the card locking structure shown in FIG. 10, showing relative positions therebetween in different states, wherein FIG. 14A shows a state where the front end of the card is in contact with the ends of the leading portions of the locking member shown in FIG. 10, FIG. 14B shows a state where the front end of the card is positioned in the insertion portions of the locking member shown in FIG. 10, and FIG. 14C shows a state where a card having a longest length within tolerance is positioned in the insertion portions of the locking member shown in FIG. 10.

### DESCRIPTION OF THE PREFERRED EMBODIMENTS

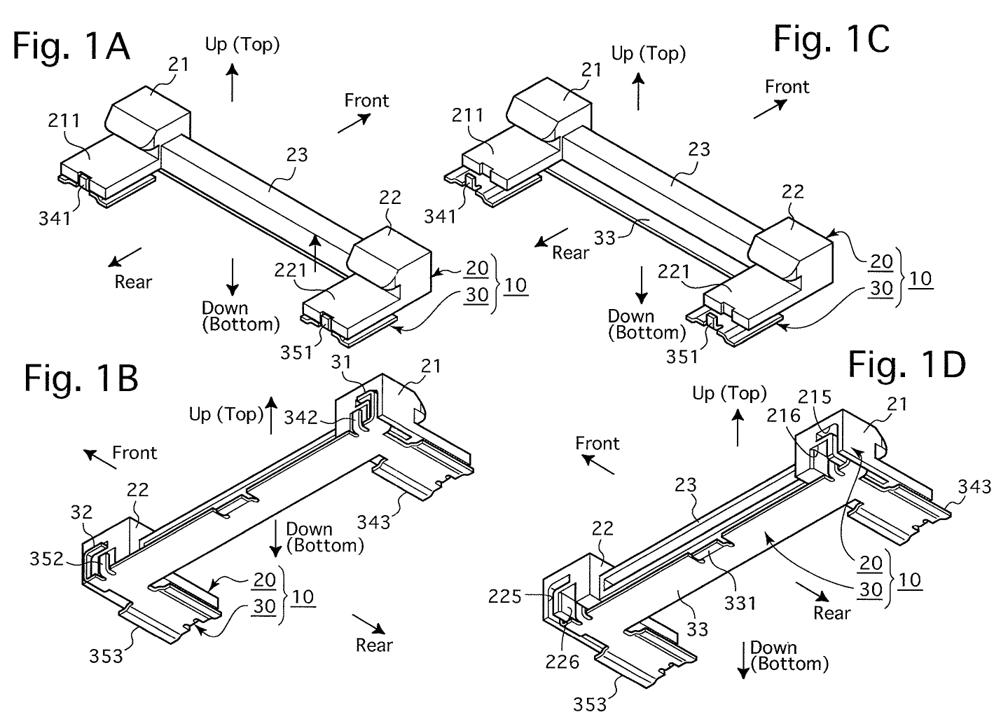

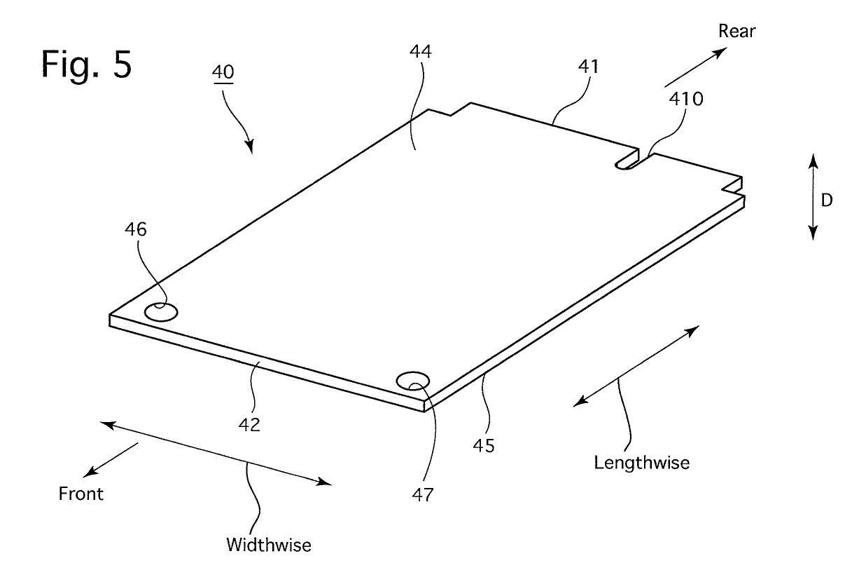

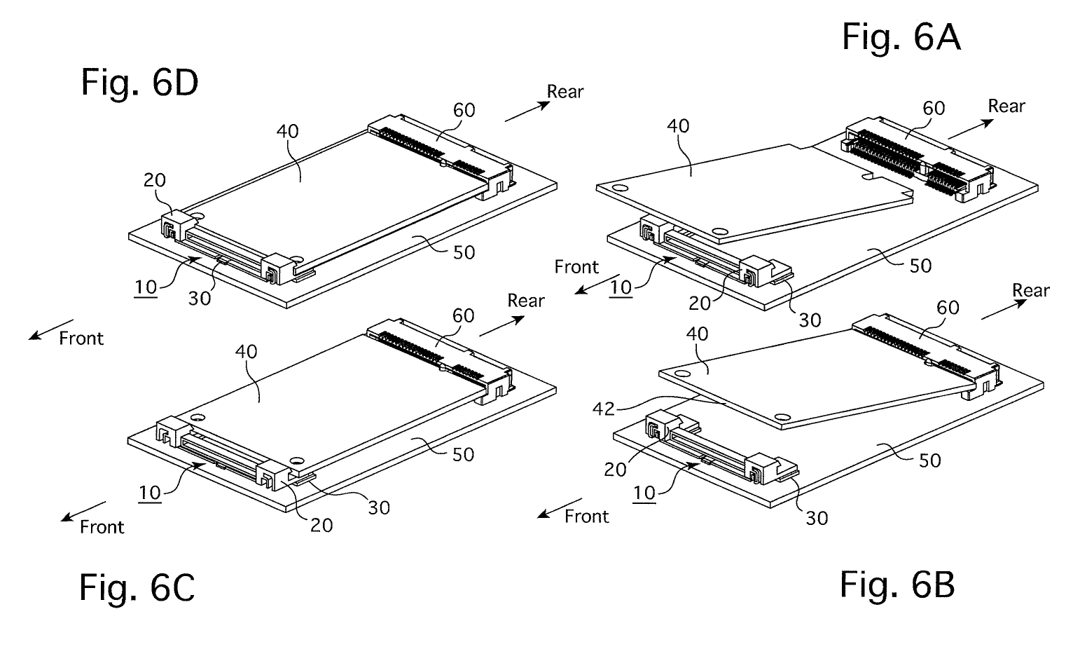

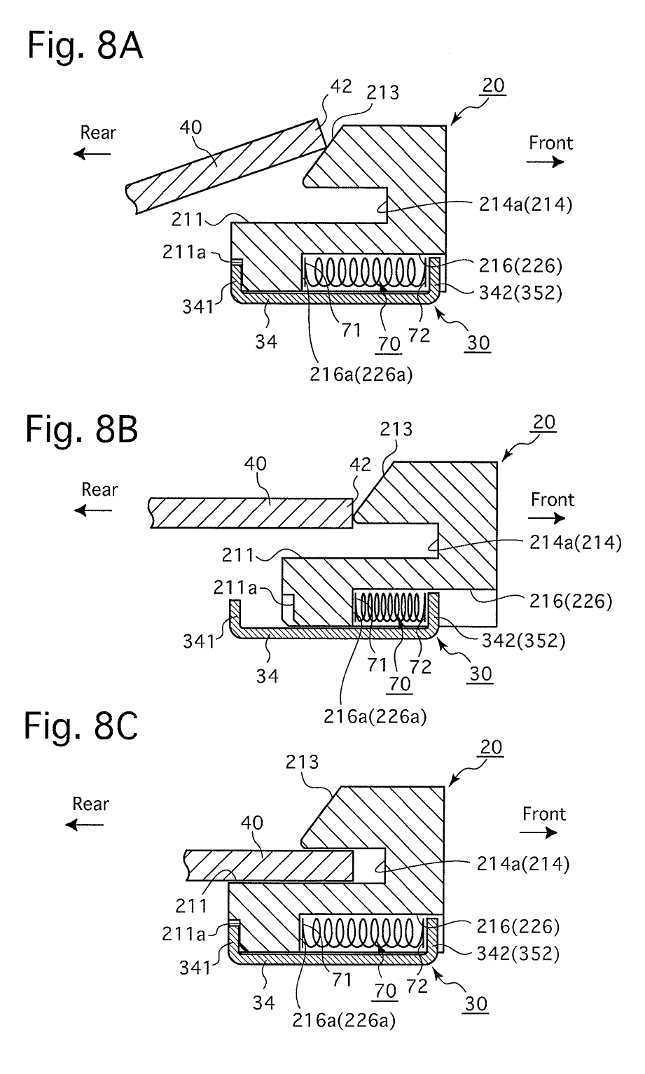

An embodiment of a card locking structure 10 according to the present invention is used with a card edge-connector 60 for electrically connecting a card (secondary board) 40 such as a memory module card to a circuit board (motherboard/primary board) 50, as shown in FIGS. 6A through 6D. The card locking structure 10 is provided with a locking member 20 and a stationary member 30 as shown in FIGS. 1A through 1D. When the card 40 shown in FIG. 5 is installed onto the circuit board 50, firstly a rear end (one end or edge) 41 of the card 40 is inserted into the card edge-connector 60, and subsequently a front end (the other end or edge) 42 of the card 40, which is on the opposite side of the card 40 from the rear end 41, is snap-fitted into the locking member 20 that is slidably held on the stationary member 30, thereby enabling the card 40 to be held (locked) on the circuit board 50 in a state where the card 40 is substantially parallel to the circuit board 50 (see FIGS. 6D and 8C). In this description, “front”, “rear” “up (top)” and “down (bottom)” are defined as shown in the drawings. Similarly, “lengthwise direction” and “widthwise direction” are defined with respect to the shape of the card 40 as shown in FIG. 5.

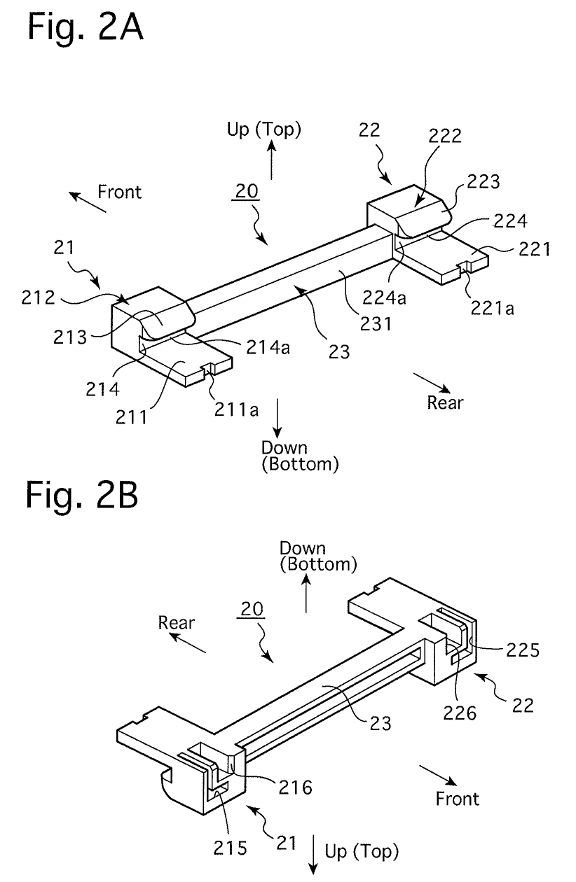

As shown in FIGS. 2A and 2B, the locking member 20 is provided with two holding portions 21 and 22 which receive and hold the front end 42 of the card 40, and is further provided with a connecting bar-like portion 23 which connects the two holding portions 21 and 22. The locking member 20 is molded of a resin material by injection molding. This resin material can be 9T nylon, 66 nylon, 46 nylon, other nylons (PA), liquid crystal polymer (LCP), polyphenylene sulphide (PPS), or polybutylene terephthalate (PBT).

The two holding portions 21 and 22 are provided with two receiving portions 211 and 221, respectively, which receive and support a bottom surface 45 of the card 40, and two locking portions 212 and 222, respectively, which prevent the card 40 from moving upward (i.e., away from the circuit board 50).

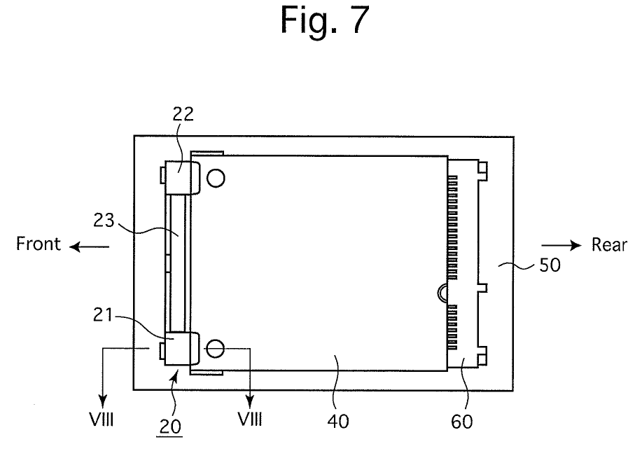

Each of the two receiving portions 211 and 221 is a plate-like member which is positioned to lie in a plane substantially parallel to the top surface of the circuit board 50 when the locking member 20 is supported by the stationary member 30 that is fixedly mounted on the circuit board 50. The two locking portions 212 and 222 are positioned above the two receiving portions 211 and 221, respectively, and are provided with two leading portions 213 and 223, respectively. The top surfaces of the leading portions (oblique portions) 213 and 223 are inclined with respect to a plane parallel to the top surfaces of the receiving portions 211 and 221 so as to approach the receiving portions 211 and 221 in a direction toward the ends (rear ends) of the leading portions 213 and 223, respectively. The receiving portions 211 and 221 are formed to be longer than the leading portions 213 and 223 in the forward/rearward direction (horizontal direction as viewed in FIG. 7) in which the top surfaces of the leading portions 213 and 223 are inclined forwardly or rearwardly. The space between the leading portion 213 and the receiving portion 211 constitutes an insertion portion 214 in which one side of the front end 42 is inserted so as to be accommodated, while the space between the leading portion 223 and the receiving portion 221 constitutes an insertion portion 224 in which the other side of the front end 42 is inserted to be accommodated. The locking portions 212 and 222 are provided in the insertion portions 214 and 224 with (front) end surfaces 214a and 224a, respectively, which extend vertically (vertical direction as viewed in FIG. 2). The end surfaces 214a and 224a are positioned behind a rear side surface 231 of the connecting bar-like portion 23 (i.e., closer to the card edge-connector 60 than the rear side surface 231) in the rearward direction.

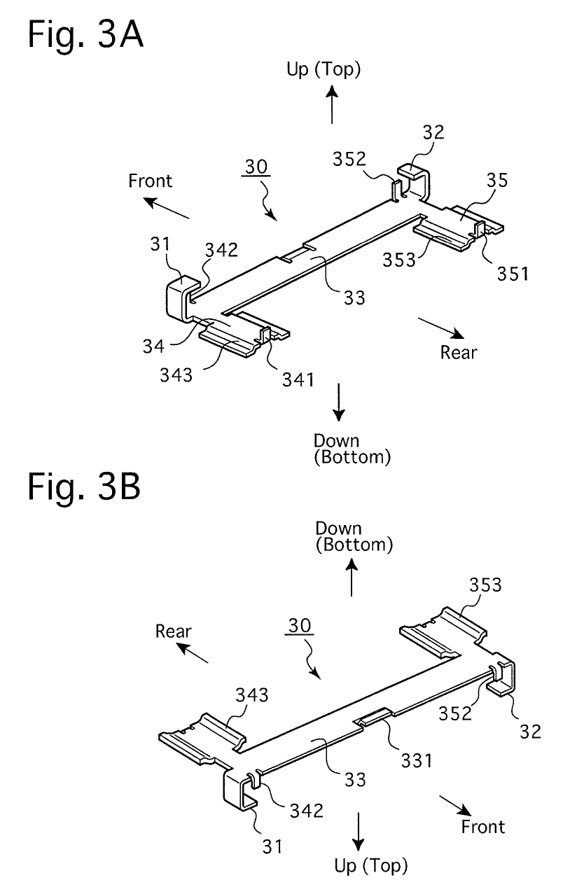

The receiving portion 211 is provided, on a rear end face thereof at substantially the center of this rear end face, with a recess 211a which can accommodate an associated rear stop projection 341 of the stationary member 30 (see FIG. 3A). Likewise, the receiving portion 221 is provided, on a rear end face thereof at substantially the center of this rear end face, with a recess 221a which can accommodate an associated rear stop projection 351 of the stationary member 30 (see FIG. 3A).

The two holding portions 21 and 22 are provided on bottom surfaces thereof with two guide recesses 215 and 225 and two accommodation recesses 216 and 226 all of which extend in the forward/rearward direction, respectively (see FIG. 2B). Two compression coil springs (biasing members) 70 are installed in the two accommodation recesses 216 and 226, respectively (see FIGS. 8A through 8C). Each of the two guide recesses 215 and 225 is in the shape of a substantially letter L in cross section taken along a plane orthogonal to the forward/rearward direction. The widths of the locking portion 212 and the receiving portion 211 in the lengthwise direction of the connecting bar-like portion 23 (in the widthwise direction of the card 40 when installed on the motherboard 50) are substantially identical to each other. Likewise, the widths of the locking portion 222 and the receiving portion 221 in the lengthwise direction of the connecting bar-like portion 23 (in the widthwise direction of the card 40 when installed on the motherboard 50) are substantially identical to each other. In addition, the widths of the locking member 20 and the stationary member 30 are substantially the same. In consideration of the dynamic stability at the time of installation and removal of the card 40 to and from the locking member 20, it is desirable that the accommodation recess 216 be formed on the holding portion 21 at a position on the bottom surface thereon which corresponds to the centers of the receiving portion 211 and the leading portion 213 in the widthwise direction thereof and that the accommodation recess 226 be formed on the holding portion 22 at a position on the bottom surface thereon which corresponds to the centers of the receiving portion 221 and the leading portion 223 in the widthwise direction thereof.

The end surfaces 214a and 224a of the locking portions 212 and 222 can be formed to lie in a plane in which the rear side surface 231 of the connecting bar-like portion 23 lies. Additionally, the locking member 20 can be made without the connecting bar-like portion 23 if provided with a guide portion which limits movements of the holding portions 21 and 22 in the widthwise direction thereof (in the vertical direction as viewed in FIG. 7). It is possible for the locking member 20 to be provided with more than two holding portions corresponding to the holding portions 21 and 22.

The stationary member 30 shown in FIGS. 3A and 3B is provided with two guide portions 31 and 32 and a connecting support portion 33 which connects the two guide portions 31 and 32. The two guide portions 31 and 32 are slidably engaged in the guide recesses 215 and 225 of the locking member 20, respectively. The stationary member 30 is further provided, in the vicinity of the opposite ends of the connecting support portion 33 in the widthwise direction of the stationary member 30, with two sliding surfaces 34 and 35, respectively. The stationary member 30 is fixedly mounted to the circuit board 50 at a predetermined position thereon by a known fixing means such as soldering. The stationary member 30 is made of metal such as phosphor bronze (Cu—Sn copper-based alloy), Corson copper-based alloy (Cu—Ni—Si copper-based alloy), another copper-based alloy or a stainless steel (SUS), by stamping with a progressive die. The surface of the stationary member 30 is plated with metal such as gold, tin-copper or tin-lead.

The guide portions 31 and 32 of the stationary member 30 are formed by bending so that the ends of the guide portions 31 and 32 in the vertical direction as viewed in FIGS. 3A and 3B are bent at right angles in directions to approach each other, so that each of the guide portions 31 and 32 has the shape of a substantially letter L in a side view. The connecting support portion 33 is an elongated plate portion, the opposite ends of which are respectively provided with the guide portions 31 and 32 that stand upright. The two sliding surfaces 34 and 35 lie in a plane in which the connecting support portion 33 lies, and extend parallel to each other in a direction orthogonal to the lengthwise direction of the connecting support portion 33.

The stationary member 30 is provided, at the rear end of the sliding surface 34 in the rearward direction (the direction of elongation of the sliding surface 34), with the rear stop projection 341 which projects vertically upward, and is further provided, at the front end of the sliding surface 34 in the forward direction, with a front stop projection 342 which projects vertically upward. Likewise, the stationary member 30 is provided, at the rear end of the sliding surface 35 in the rearward direction (the direction of elongation of the sliding surface 35), with the rear stop projection 351 which projects vertically upward, and is further provided, at the front end of the sliding surface 35 in the forward direction, with a front stop projection 352 which projects vertically upward. The front stop projections 342 and 352 are formed by bending to stand uprightly after the two compression coil springs 70 have been installed in the two accommodation recesses 216 and 226, respectively, following the mounting of the locking member 20 onto the stationary member 30.

The stationary member 30 is provided, at opposite ends of the sliding surface 34 in the widthwise direction thereof, with two mounting portions 343, respectively, which are fixed to the upper surface of the circuit board 50 when the stationary board 30 is mounted to the circuit board 50, and is likewise provided, at opposite ends of the sliding surface 35 in the widthwise direction thereof, with two mounting portions 353, respectively, which are fixed to the upper surface of the circuit board 50 when the stationary board 30 is mounted to the circuit board 50. The connecting support portion 33 is provided, at substantially the center thereof in the widthwise direction of the stationary member 30, with a mounting/supporting portion 331 which projects downward to be fixed to the upper surface of the circuit board 50 when the stationary board 30 is mounted to the circuit board 50. Each of the two mounting portions 343 is provided with a stepped portion which is stepped in the direction of elongation of the connecting support portion 33, while each of the two mounting portions 353 is provided with a stepped portion which is stepped in the direction of elongation of the connecting support portion 33. This structure increases the mechanical strength of the mounting portions 343 and 353 and the mounting/supporting portion 331, and enlarges the area of the connecting support portion 33 which is to be fixed to the circuit board 50 by soldering to thereby improve the strength of each solder joint between the stationary member 30 and the circuit board 50. Moreover, the above described construction makes it possible to prevent the stationary member 30 from tilting or tripping because the stationary member 30 is supported by the circuit board 50 at three positions of the mounting portions 343 and 353, and the mounting/supporting portion 331.

The stationary member 30 can be mounted to either a board different from the circuit board 50, to which the card edge-connector 60 is mounted, or a part of a device to which the card is installed. Moreover, the stationary member 30 can be replaced by another member on the circuit board 50, a part of the housing of the device, or any board other than the circuit board 50 and the card 40 if the locking member 20 can be held in position without using the stationary member 30. In this case, if the card 40 can be held by the locking member 20, it is possible to provide the two guide portions 31 and 32 at two positions corresponding to the two holding portions 21 and 22, respectively, without providing the connecting support portion 33.

The number of the holding portions (21, 22) of the locking member 20 and the corresponding number of the sliding surfaces (34, 35) of the stationary member 30 are not limited solely to two; one or more than two holding portions and corresponding one or more than two sliding surfaces can be provided at any given positions corresponding to the front end of the card 40 at any given intervals in accordance with a required lock strength and a required drop-impact resistance. Although the two holding portions 21 and 22 of the locking member 20 are respectively arranged to correspond to the opposite sides of the front end 42 of the card 40 in the above described embodiment of the card locking structure, it is possible for the locking member 20 to be provided with only one holding portion at a position corresponding to the center of the front end 42 of the card 40 or more than two holding portions as long as the holding portion(or portions) and the sliding surface (or surfaces) are provided correspondingly.

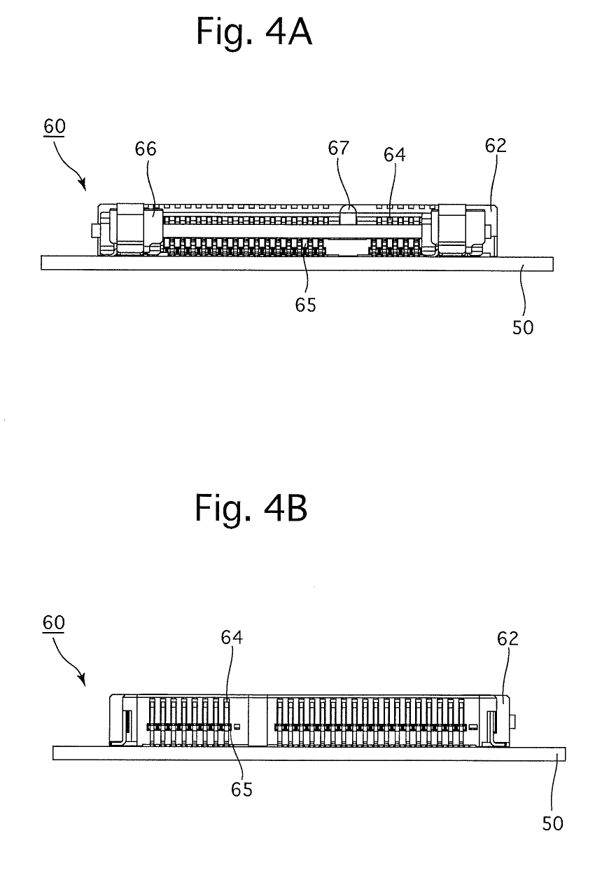

As shown in FIGS. 4A and 4B, the card edge-connector 60 is provided with a substantially rectangular-prism-shaped housing 62 made of an insulating material and two rows of linear contact arrays 64 and 65 which are fixed to the housing 62 to be arranged along the widthwise direction of the housing 62 (the horizontal direction as viewed in FIG. 4). The housing 62 is provided on a front surface thereof with a recess 66 for receiving the card 40. The housing 62 is provided, in the recess 66 at a position deviating from the center of the housing 62 in the widthwise direction thereof, with a projection 67 which prevents the card 40 from being inserted into the card edge-connector 60 in the wrong direction. The housing 62 is molded from an insulating synthetic resin.

The two rows of linear contact arrays 64 and 65 are formed by punching metal plates and press-fitting the punched metal plates into the housing 62 from behind so that front ends of the contact arrays 64 and 65 project forward into the recess 66. The two rows of linear contact arrays 64 and 65 are arranged so that a contacting portion containing a plurality of contacts (not shown) and another contacting portion containing a plurality of contacts (not shown) which are formed on a top surface 44 and a bottom surface 45 of the rear end 41 of the card 40 come in contact with the linear contact arrays 64 and 65, respectively, when the card 40 is inserted into the card edge-connector 60 in the right direction. The card edge-connector 60 is fixed to the circuit board 50.

The card 40 shown in FIG. 5 is in the shape of a substantially flat plate, for instance, a PCI Express Mini Card, a SO-DIMM (Small Outline Dual-in-line Memory Module) or another type of memory module. The aforementioned plurality of contacts of the contacting portion formed on the top surface 44 of the rear end 41 of the card 40 are arranged in the widthwise direction (shown by an arrow W in FIG. 5) and the aforementioned plurality of contacts of the contacting portion formed on the bottom surface 45 of the rear end 41 of the card 40 are also arranged in the widthwise direction (shown by an arrow W in FIG. 5). The shapes of such contacting portions formed on the top surface 44 and the bottom surface 45 of the rear end 41 are known in the art and accordingly not shown in the drawings. The rear end 41 of the card 40 is provided with a cutout portion 410 in which the projection 67 of the housing 62 is engaged when the card 40 is inserted into the card edge-connector 60 in the proper direction.

The procedure for installing the card 40 to the circuit board 50 will be hereinafter discussed with reference to FIGS. 6A through 8C. Firstly, the card locking structure 10 is assembled, and subsequently the assembled card locking structure 10 and the card edge-connector 60 are mounted onto the circuit board 50.

The card locking structure 10 is mounted to the circuit board 50 at a predetermined position thereon while a part of the top surface of the connecting bar-like portion 23 in the vicinity of the center thereof or the top surfaces of the two holding portions 21 and 22 are vacuum held via a vacuum suction device (not shown). In this state, the card locking structure 10 is fixed to the circuit board 50 by soldering the two mounting portions 343 and the two mounting portions 353 of the stationary member 30 to the circuit board 50 so that the rear stop projections 341 and 351 and the front stop projections 342 and 352 are positioned on the near side and the far side of the card edge-connector 60, respectively. The predetermined position on the circuit board 50 at which the stationary member 30 is mounted is such a position where the front end 42 of the card 40 is accommodated in the insertion portions 214 and 224 of the locking member 20, which is supported by the stationary member 30, while the locking member 20 is biased toward the card edge-connector 60 by the two coil springs 70.

The card locking structure 10 is assembled by installing the locking member 20 to the stationary member 30 via the two coil springs 70. Therefore, after the card locking structure 10 is mounted to the circuit board 50, the card locking structure 20 is movable relative to the stationary member 30 and the circuit board 50.

The locking member 20 is installed into the stationary member 30 by inserting the two guide portions 215 and 225 of the locking member 20 over the two guide portions 31 and 32, respectively, from the rear side of the stationary member 30. This prevents the locking member 20 from moving in either the vertical direction (the direction of height of the locking member 20 in a state where the card locking structure 10 is mounted on the circuit board 50) or the widthwise direction of the card 40. In a state where the two holding portions 21 and 22 have been slidingly moved on the sliding surfaces 34 and 35, respectively, so that the two rear stop projections 341 and 351 come into contact with bottoms of the two recesses 211a and 221a, respectively, the two coil springs 70 are inserted into the accommodation recesses 216 and 226 so that the rear ends 71 of the two coil springs 70 come in contact with end surfaces 216a and 226a in the accommodation recesses 216 and 226, respectively.

Subsequently, the front stop projections 342 and 352 are bent upright to be in contact with the front ends of the two coil springs 70, respectively. At this time, the distance between the rear end surfaces 216a and 226a and the front stop projections 342 and 352 is predetermined to be smaller than the free length of each coil spring 70. Therefore, the locking member 20 is continuously biased toward the card edge-connector 60 since the rear ends 71 of the coil springs 70 are in contact with the end surfaces 216a and 226a, respectively, while the front ends 72 of the coil springs 70 are in contact with the front stop projections 342 and 352, respectively. On the other hand, the receiving portions 211 and 221 are prevented from moving toward the card edge-connector 60 beyond the rear stop projections 341 and 351 of the stationary member 30 by the engagement of the rear stop projections 341 and 351 of the stationary member 30 with the bottoms of the two recesses 211a and 221a, respectively. By adjusting the positions of the end surfaces 216a and 226a, which are in contact with the rear ends of the two coil springs 70, respectively, and also the spring rate of the two coil springs 70, the holding power and the stroke of the card 40 can be easily adjusted with no modifications to the outer dimensions of the card 40, which desirably increases the degree of design freedom.

It is desirable for the central axes of the two locking portions 212 and 222 of the locking member 20 to be substantially aligned with the axes of the two coil springs 70, respectively, and for the central axes of the mounting portions 343 and the mounting portions 353 to be substantially aligned with the axes of the two coil springs 70, respectively, in order to facilitate the dynamic stability of the locking member 20. This configuration makes it possible to prevent moments such as bending moment or torsion moment from occurring upon the installation of the card 40, thus making it possible to stabilize the behavior of the locking member 20 with no unwanted moment being exerted on the mounting portions 343 and 353.

In conventional latches, the follow-up ability thereof tends to decrease due to the size of the leaf spring including a latching portion of the latch being reduced in order to satisfy the demand for reduction in height of the latch, etc. Additionally, the load on members which correspond to the locking member 20 and the stationary member 30 by the leaf spring tends to be greater as the amount of displacement of one of such members relative to the other increases. Namely, the operating physical force increases as this amount of displacement is increased. In addition, this amount of displacement cannot be increased because the leaf spring is apt to be plastic-deformed by a small deformation of the leaf spring.

In contrast, according to the present invention, the coil springs 70 have a good follow-up ability and can stabilize the operating physical force because the load on the locking member 20 and the stationary member 30 varies little with respect to the amount of displacement of the locking member 20 relative to the stationary member 30. Additionally, the aforementioned load and the aforementioned amount of displacement can be easily adjusted and set by changing the diameter and the number of coils of each coil spring 70.

According to the configuration of the above illustrated embodiment, even in a state where the two rear stop projections 341 and 351 are in contact with the bottoms of the two recesses 211a and 221a, respectively, the locking member 20 is continuously biased (pre-loaded) toward the card edge-connector 60 by the resilient force of the coil springs 70. Therefore, in order to move the locking member 20 in a direction away from the card edge-connector 60, a force greater than the pre-loading force is required, so that it is difficult for the locking member 20 to move by its own weight even if vibrations or an impact is exerted on the locking member 20. Therefore, even in the case where the card 40 is made with minimum dimensional tolerances and where the amount of overlap between the card 40 and the leading portions 213 and 223 of the locking member 20 is small, the card 40 can be securely held in the insertion portions 214 and 224 while noise caused by movements of the locking member 20 and resonance can be prevented from occurring. Additionally, if pre-loading is applied to the locking member 20, the locking member 20 can be moved by a large amount of movement relative to the stationary member 30 due to the use of the coil springs 70.

When the card 40 is mounted on the circuit board 50, firstly the rear end 41 of the card 40 is inserted into the housing 62 of the card edge-connector 60 in a state where the card 40 is inclined to the circuit board 50 so that the front end 42 of the card 40 is positioned farther from the circuit board 50 than the rear end 42 of the card 40 as shown in FIG. 6B. At this stage, the rear end 41 of the card 40 is inserted into the housing 62 to be sandwiched between the two rows of linear contact arrays 64 and 65. Due to this insertion of the rear end 41 of the card 40 in between the two rows of linear contact arrays 64 and 65, the two contacting portions formed on the top surface 44 and the bottom surface 45 of the rear end 41 of the card 40 are electrically connected to the two rows of linear contact arrays 64 and 65, respectively. At this stage, the card 40 is still in an unlocked state in which the card 40 can rotate about the rear end 41 in directions to move the front end 42 of the card 40 toward and away from the card locking structure 10. Upon the insertion of the rear end 41 of the card 40 into the housing 62, the projection 67 that is formed on the housing 62 of the card edge-connector 60 is engaged in the cutout portion 410 of the card 40. Therefore, even if one tries to insert the card 40 into the card edge-connector 60 upside down, the projection 67 of the card edge-connector 60 cannot be engaged in the cutout portion 410 of the card 40 because the projection 67 and the cutout portion 410 are formed at off-centered positions on the housing 62 and the rear end 41 of the card 40 in the widthwise direction thereof, respectively. Consequently, the card 40 is prevented from being inserted into the card edge-connector 60 upside down.

Subsequently, rotating the card 40 about the rear end 41 thereof in a direction to bring the front end 42 close to the circuit board 50 causes the lower ridge of the front end 42 of the card 40 to come into contact with the leading portions 213 and 223 (see FIG. 8A). From this state, further rotating the card 40 in the same rotation direction causes the front end 42 to move downward (toward the circuit board 50) while sliding on the leading portions 213 and 223, which in turn causes the locking member 20 to slide on the stationary member 30 in a direction away from the card edge-connector 60 against the spring force of the coil springs 70. Each coil spring 70 is fully compressed when the edge of the front end 42 of the card 40 comes into contact with the ends of the leading portions 213 and 223 as shown in FIG. 8B.

Further rotating the card 40 about the rear end 41 thereof in the same rotation direction to move the front end 42 of the card 40 downward over the ends of the leading portions 213 and 223 causes the front end 42 of the card 40 to come into contact with the receiving portions 211 and 221 of the holding portions 21 and 22 to thereby be prevented from further moving downward, toward the circuit board 50. Thereupon, the locking member 20 which is released from the force applied from the card 40 moves toward the card edge-connector 60 by the resilient spring force of the coil springs 70, and subsequently stops moving at a position where the front end 42 of the card 40 is accommodated in the insertion portions 214 and 224 with the bottoms of the two recesses 211a and 221a of the two holding portions 21 and 22 coming into contact with the two rear stop projections 341 and 351 of the stationary member 30, respectively (see FIGS. 6D, 7 and 8C).

The above described operations bring the card 40 to be substantially parallel to the circuit board 50, which completes the installation of the card 40 to the circuit board 50. At this time, the card 40 is in a locked state, in which the card 40 is prevented from moving by the card edge-connector 60 and the locking members 212 and 222, with the rear end 41 of the card 40 being accommodated and held in the card edge-connector 60 and the front end 42 of the card 40 being accommodated and held in the insertion portions 214 and 224 of the locking member 20.

This locked state of the card 40 can be released by lifting the front end 42 of the card 40 in a direction away from the circuit board 50 in a state where the locking member 20 has been moved in a direction away from the card edge-connector 60 against the spring force of the coil springs 70.

It is desirable for each of the leading portions 213 and 223 of the locking portions 212 and 222 be provided over the surface thereof with a member having an excellent sliding property such as a metal member in order for the edge of the front end 42 of the card 40 to smoothly slide on the leading portions 213 and 223 when the front end 42 of the card 40 is snap-fitted into the locking member 20 to be fixed thereto.

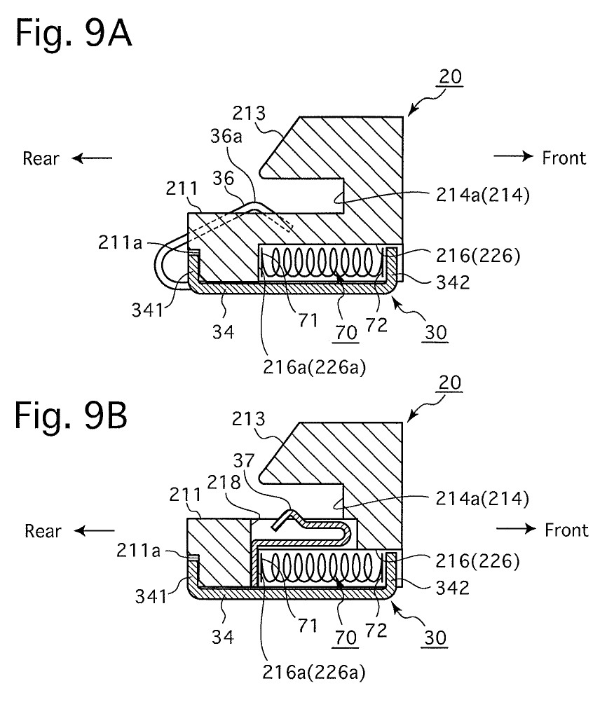

FIGS. 9A and 9B show modified embodiments of the present invention, respectively. In the embodiment shown in FIG. 9A, the card locking structure 10 is provided in the vicinity of the receiving portions 211 and 221 with two leaf spring members (resilient grounding members) 36 (only one of them is shown in FIG. 9A), respectively, which firstly extend rearward (leftward as viewed in FIG. 9A) from the rear ends of the two sliding surfaces 34 and 35 and subsequently bend forwards. Free end portions of the two spring members 36 are bent to be formed as bent contact portions 36a, each having an inverted V-shape in cross section. The bent contact portions 36a of the two spring members 36 extend to be positioned either above the receiving portions 211 and 221 or inside the insertion portions 214 and 224, respectively. With this structure using the two springs members 36, the bent contact portions 36a can be made to be in resilient contact with ground patterns (not shown) formed on the bottom surface 45 of the card 40, which makes it possible to establish a ground for the card 40 via the stationary member 30 with reliability. Although the two spring members 36 can be positioned inside, outside or in the vicinity of the receiving portions 211 and 221 (on the side thereof closer to the card edge-connector 60), respectively, it is desirable that the two spring members 36 be positioned inside the receiving portions 211 and 221, respectively, since the possibility of the receiving portions 211 and 221 being accidentally touched and deformed can be reduced during delivery or during other circumstances.

In the modified embodiment shown in FIG. 9B, the receiving portions 211 and 221 are provided therein with two through holes 218 which extend from top surfaces of the receiving portions 211 and 221 into the accommodation recesses 216 and 226, respectively, while two spring members 37 are fixed to the locking member 20 to extend from the rear end surfaces 216a and 226a, which are in contact with the rear ends 71 of the two coil springs 70, either up to positions above the receiving portions 211 and 221 or into the insertion portions 214 and 224, respectively. According to this structure using the spring members 37, the spring members 37 and the card 40 which is held by the locking member 20 are in contact with each other, so that a ground for the card 40 can be established via the stationary member 30.

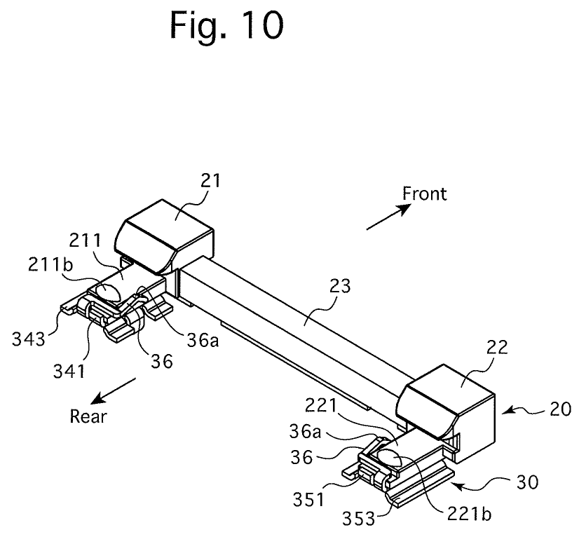

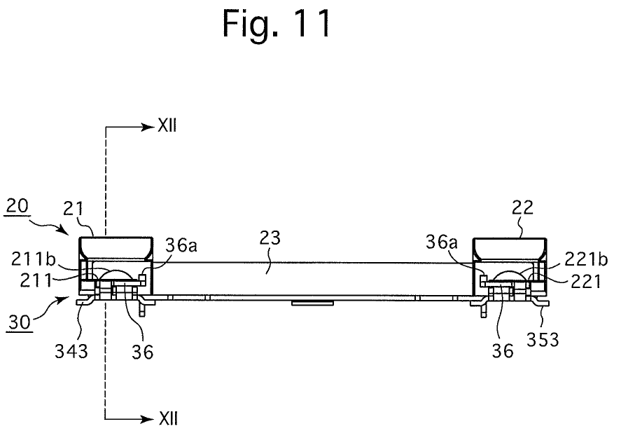

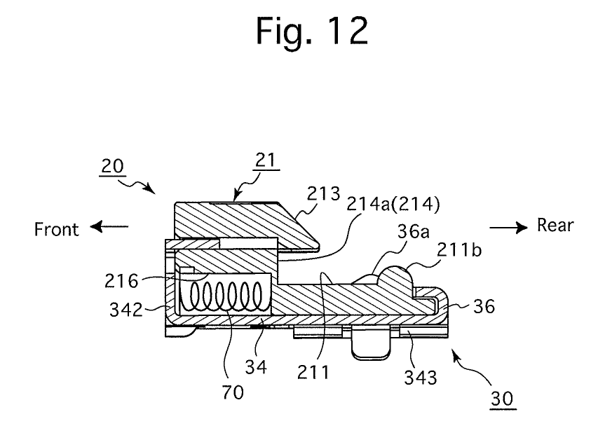

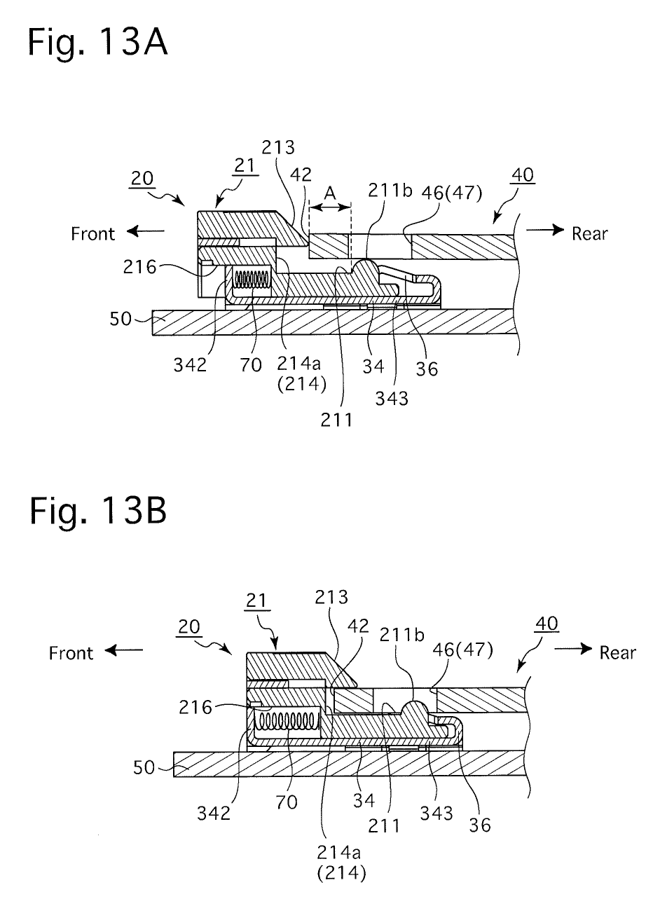

FIGS. 10 through 14C show another modified embodiment of the present invention. In this modified embodiment, the two receiving portions 211 and 221 are provided thereon with two protrusions 211b and 221b, respectively. Each of the two protrusions 211b and 221b has a curved outer surface which is curved upwards. The two protrusions 211b and 221b are formed on the two receiving portions 211 and 221 at predetermined positions thereon to be engaged in receiving holes (through holes/receiving portions) 46 and 47 (see FIGS. 5 and 13) formed in the card 40 (the card 40 made with dimensional tolerances) in the vicinity of opposite ends thereof in the widthwise direction of the card 40, respectively, when the rear end 41 and the front end 42 of the card 40 are respectively accommodated and held in the card edge-connector 60 and the locking member 20 in a state where the card 40 is substantially parallel to the circuit board 50. Similar to the embodiment of the card locking structure 10 shown in FIG. 9A, the embodiment of the card locking structure 10 shown in FIGS. 10 through 14C is also provided with two spring members 36. Although FIGS. 12, 13A and 13B show longitudinal sectional views of the card locking structure 20 and associated elements taken along a vertical plane on the holding portion 21 side, similar sectional views on the holding portion 22 side of the card locking structure 20 are not shown in the drawings because the structure of a portion of the card locking structure 10 and associated elements on the holding portion 22 side is the same as that on the holding portion 21 side that is shown in FIGS. 12, 13A and 13B.

It is desirable that the two protrusions 211b and 221b be respectively formed on the two receiving portions 211 and 221 to satisfy conditions which will be discussed hereinafter.

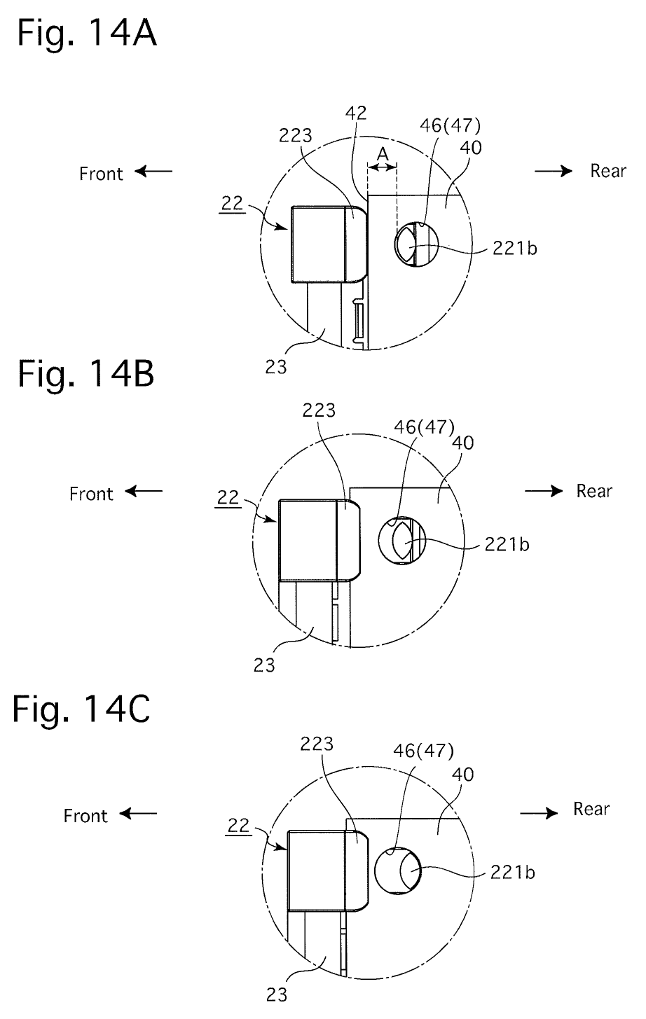

In regard to the front ends (the left ends as viewed in FIG. 12 through 14C) of the two protrusions 211b and 221b in the direction of insertion of the card 40, it is desirable that the two protrusions 211b and 221b be positioned so that the positions of the front ends of the two protrusions 211b and 221b substantially correspond to the positions of the front ends of the two receiving holes 46 and 47, respectively, when the locking member 20 has been moved in a direction away from the card edge-connector 60 by making the front end 42 of the card 40 come in contact with the rear ends of the leading portions 213 and 223. In other words, it is desirable that the distance A (see FIGS. 13A and 14A) between the rear ends of the leading portions 213 and 223 and the front ends of the two protrusions 211b and 221b, when the front end 42 of the card 40 is made to come in contact with the rear ends of the leading portions 213 and 223, substantially corresponds to the distance from the front end 42 of the card 40 to the front ends of the two receiving holes 46 and 47. Although FIGS. 14A, 14B and 14C show enlarged plan views of portions of the card locking structure 20 and associated elements on the holding portion 22 side, similar plan views on the holding portion 21 side are not shown in the drawings because the structure of a portion of the locking mechanism 10 and associated elements on the holding portion 21 side is the same as that on the holding portion 22 side that is shown in FIGS. 14A, 14B and 14C.

On the other hand, in regard to the rear ends (the right ends as viewed in FIG. 12 through 14C) of the two protrusions 211b and 221b in the direction of insertion of the card 40, it is desirable that the two protrusions 211b and 221b be positioned so that the positions of the rear ends of the two protrusions 211b and 221b substantially correspond to the positions of the rear ends of the receiving holes 46 and 47, respectively, when the front end 42 of the card 40 having the longest length within dimensional tolerances is accommodated in the insertion portions 214 and 224 of the locking member 20 (see FIG. 14C). Positioning the front and rear ends of the two protrusions 211b and 221b at the above described respective positions allows the two protrusions 211b and 221b to be securely engaged in the receiving holes 46 and 47, respectively, even when the card 40 which is short within dimensional tolerances is accommodated in the insertion portions 214 and 224 of the locking member 20 (see FIG. 14B).

In regard to the lengths of the two protrusions 211b and 221b in the widthwise direction of the card 40 (vertical direction as viewed in FIGS. 14A, 14B and 14C), it is desirable that the play between the two protrusions 211b and 221b and the receiving holes 46 and 47 in the widthwise direction are smaller than the play between the protrusions 211b and 221b and the holes 46 and 47 in the lengthwise direction of the card 40. In this manner, forming the protrusions 211b and 221b so that the widths of the protrusions 211b and 221b in the widthwise direction of the card 40 become greater than the lengths of the protrusions 211b and 221b in the lengthwise direction of the card 40 (in the horizontal direction as viewed in FIGS. 14A, 14B and 14C) and so that the outer surfaces of the protrusions 211b and 221b are formed to be curved surfaces which are curved upward makes it possible to prevent the aforementioned rotation displacement from occurring even if the size of the card 40 varies within relatively large dimensional tolerances.

Although the protrusions 211b and 221b have only to be formed to protrude so as to be engaged in the receiving holes 46 and 47 of the card 40, respectively, it is desirable that the outer surfaces of the protrusions 211b and 221b be formed to be curved surfaces which are curved upward from the viewpoint of the prevention of dust (fine shavings) which may be produced by friction between the protrusions 211b and 221b and the edges of the receiving holes 46 and 47 of the card 40. Such a curved surface of each protrusion 211b and 221b can be spherical or oval in shape.

As another embodiment of the card locking structure, the front end 42 of the card 40 can be made to maintain contact with the end surfaces 214a and 224a of the insertion portions 214 and 224, i.e., the amount of overlap between the card 40 and the locking member 20 can be made constant after installation of the card 40. This can be made possible by changing the stroke of the locking member 20 relative to the stationary member 30 by adjusting the positions of the rear stop projections 341 and 351 and by changing the property of the coil springs 70, respectively.

In the above illustrated embodiment of the card locking structure 10, the locking member 20 is made of synthetic resin and is fixed to the stationary member 30 via the coil springs (biasing members) 70 to be slidable on the stationary member 30. Therefore, mechanical stress or bending moment caused by the coil springs 70 is prevented from being directly transferred to the joint between the stationary member 30 and the circuit board 50, which makes it possible to prevent the operator from being injured and further prevent the joint from being damaged.

Since the coil springs 70 are used as biasing members, an excellent spring property thereof makes it possible to secure a sufficient stroke relative to tolerances of the card 40 or the like. Moreover, since neither the locking member 20 nor the stationary member 30 is provided with any warp-prone members which would warp at the time of installation or removal of the card 40, the behavior of the locking member 20 can be stabilized, which makes it possible to hold the card 40 securely with stability.

Furthermore, since the shape of the card locking structure 10 can be made simpler than those of conventional latches, and since the locking member 20 can slide smoothly on the stationary member 30, the locking member 20 moves with a low possibility of jerking while moving and is not easily deformed or damaged even if operated in an unexpected manner (e.g., being operated in a manner to induce a jerking motion of the locking member 20), which makes it possible to maintain the performance of the card locking structure 10.

Obvious changes may be made in the specific embodiments of the present invention described herein, such modifications being within the spirit and scope of the invention claimed. It is indicated that all matter contained herein is illustrative and does not limit the scope of the present invention.

What is claimed is:

1. A card locking structure for holding a card between said card locking structure and a card edge-connector provided on a motherboard, one end of said card being inserted into said card edge-connector, said card locking structure comprising:
a locking member made of synthetic resin which is movable relative to said motherboard; and
at least one biasing member which biases said locking member toward said card edge-connector,
wherein said card is held in a state so that said card is substantially parallel to said motherboard by firstly inserting said one end of said card into said card edge-connector and subsequently accommodating the other end of said card in said locking member.

2. The card locking structure according to claim 1, wherein said biasing member comprises a coil spring which is positioned to expand and contract in a direction between said card-edge connector and said locking member.

3. The card locking structure according to claim 2, wherein said locking member comprises at least one holding portion which accommodates said other end of said card and which is positioned substantially on an axis of said coil spring.

4. The card locking structure according to claim 1, further comprising a stationary member made of metal,
wherein said locking member is held by said stationary member via said biasing member to be movable relative to said stationary member.

5. The card locking structure according to claim 4, wherein said stationary member is mounted on said motherboard.

6. The card locking structure according to claim 4, wherein said stationary member is an element of said motherboard.

7. The card locking structure according to claim 4, wherein said stationary member constitutes a part of a member of a device to which said motherboard and said card are installed.

8. The card locking structure according to claim 4, wherein said stationary member is mounted on a board different from said motherboard.

9. The card locking structure according to claim 2, wherein a recess in which said coil spring is accommodated is formed in said locking member.

10. The card locking structure according to claim 2, wherein said stationary member comprises at least one mounting portion which is directly mounted to said motherboard, and
wherein a central axis of said mounting portion is substantially aligned with an axis of said coil spring.

11. The card locking structure according to claim 3, wherein said holding portion comprises a locking portion which prevents said card from moving in a direction away from said motherboard, and
wherein a central axis of said locking portion is substantially aligned with an axis of said coil spring.

12. The card locking structure according to claim 3, wherein said holding portion comprises at least two holding portions.

13. The card locking structure according to claim 10, wherein said mounting portion comprises at least two mounting portions.

14. The card locking structure according to claim 4, wherein said locking member moves relative to said motherboard while sliding on said motherboard.

15. The card locking structure according to claim 3, wherein said holding portion comprises a receiving portion which supports a bottom surface of said card when said holding portion accommodates said other end of said card, and
wherein said receiving portion comprises a protrusion which is engaged in a receiving portion formed in said card when said card locking structure holds said card in said state where said card is substantially parallel to said motherboard.

16. The card locking structure according to claim 15, wherein said protrusion comprises a curved outer surface which is curved toward said receiving portion of said card.

17. The card locking structure according to claim 16, wherein said curved outer surface is spherical in shape.

18. The card locking structure according to claim 16, wherein said curved outer surface is oval in shape.

19. The card locking structure according to claim 18, wherein said protrusion is elongated in the widthwise direction of said receiving portion.

20. The card locking structure according to claim 1, wherein said stationary member comprises at least one resilient grounding member which comes into resilient contact with at least one ground pattern formed on a bottom surface of said card when said other end of said card is accommodated in said locking member.

21. The card locking structure according to claim 4, wherein said stationary member comprises a plurality of stop projections engageable with said locking member to limit a range of movement of said locking member with respect to said stationary member.

22. The card locking structure according to claim 12, wherein said two holding portions are positioned at opposite ends of said locking member in a widthwise direction thereof.

23. A card locking structure for holding and locking one end of a card in a lengthwise direction thereof after the other end of said card in said lengthwise direction is inserted into a card edge-connector, wherein said card locking structure and said card edge-connector are mounted to a motherboard so as to face each other, said card locking structure comprising:
a metal stationary member fixed to said motherboard;
a plastic locking member supported by said metal stationary member to be slidable thereon; and
at least one spring which continuously biases said plastic locking member toward said card edge-connector,
wherein said card locking structure holds said card in a state where said card is substantially parallel to said motherboard by firstly inserting said other end of said card into said card edge-connector, subsequently rotating said card about said other end thereof in a direction toward said motherboard, and subsequently pressing said one end of said card against at least one oblique surface formed on said plastic locking member to make said plastic locking member slide on said metal stationary member in a direction away from said card edge-connector against a spring force of said spring to thereby make said one end of said card snap-fit into at least one insertion portion formed on said plastic locking member.
